(19) United States
(12) Patent Application Publication
(10) Pub. No.: US 2008/0237197 A1
(43) Pub. Date: Oct. 2, 2008

(54) SYSTEM AND METHOD FOR WELDING AND REAL TIME MONITORING OF SEAM WELDED PARTS

(76) Inventors: Kozo Saito, Lexington, KY (US); Mohammed A. Omar, Greenville, SC (US); Xiaocheng Jason Liu, Lexington, KY (US)

Correspondence Address: KING & SCHICKLI, PLLC, 247 NORTH BROADWAY, LEXINGTON, KY, 40507, US

(21) Appl. No.: 11/847,762

(22) Filed: Aug. 30, 2007

Related U.S. Application Data
(60) Provisional application No. 60/920,752, filed on Mar. 29, 2007.

(51) Int. Cl. B23K 11/08; B23K 11/36

(52) U.S. Cl. 219/78.01

(57) ABSTRACT

A welding system having welder with an electrode for creating a weld. The welding system may include a sensor for monitoring the weld. A method of monitoring a weld is also provided.

This application claims the benefit of U.S. Provisional Patent Application No. 60/920,752 filed Mar. 29, 2007, the disclosure of which is herein incorporated by reference.

### TECHNICAL FIELD

This invention relates generally to a system and method for welding and, more particularly, to a system and method for seam welding and monitoring of seam welded parts.

### BACKGROUND OF THE INVENTION

The art of seam welding is relatively well known. In general seam welding is a resistance-welding process that involves making a series of overlapping spot welds by means of passing one or more parts between a pair of welding electrodes. This produces a substantially continuous weld based upon the pressure applied by the welding electrodes and the electrical current passing through them.

Seam welding is commonly used in the manufacture of casings, enclosures, and other components where a continuous weld is needed. Two of the more popular applications incorporating seam welding are tubular products and stamped parts. The tubular products are often pipes/tubes that are created from a flat piece of material that is rolled together to form a seam and welded along the seam. The stamped part applications include joining overlapping portions of two or more stamped parts to create another part. For instance, when creating a vessel, such as a fuel tank, two stamped halves of the tank are welded together to form the finished tank.

During the seam welding process, defects may occur that affect the quality and integrity of the welded seam. The defects in the seam weld are often in the form of longitudinal cross-section defects and/or insufficient weld penetration. The welding electrodes are one known source of many of these defects. Specifically, overtime, wear on the electrodes can create areas where the electrodes do not properly fuse the materials being welded. The degree and rate at which the electrodes wear down is based upon different factors, including the original electrode quality, the welding parameters, and the surface/roughness profile of the parts being welded. Currently, the method to evaluate electrode wear life is periodic inspection of the electrode. This is problematic and unreliable because the electrode circumference may wear in a non-uniform manner. As a result, a number of defects may occur in the seam welding process before the electrodes are inspected and replaced.

Given the unpredictable nature of electrode wear, manufacturers will often conduct tests on the welded part to analyze the quality of the weld. Previously, inspection of welded parts was conducted using an “off-line” mode of inspection, wherein the entire part is removed from the welding system and allowed to cool prior to inspection. Unfortunately, this method is very slow and labor-intensive. Since it takes an extended period of time to inspect the weld, it is often impractical to inspect each part being welded, especially in a manufacturing setting. Accordingly, only randomly sampled parts are often inspected. This sometimes results in inconsistent product performance since each weld is not inspected and parts having inadequate welds may be undetected. Moreover, only a limited amount of data relating to the weld may be obtained.

Although other inspection methods exist, these all suffer from the limited amount of weld data they are able to produce. For instance, some evaluate only a single portion of the weld, such as the top seam, using temperature data as the sole factor used to predict seam penetration and strength of the weld. Unfortunately, this limited data relating to temperature of a single area fails to provide information relating to weld penetration. Also, such methods do not provide any manner to evaluate electrode wear life or to inspect weld seam impression.

Accordingly, the need exists for a system and method capable of nondestructive, real time inspection and monitoring of the multiple portions of the welded part. The system and method would be capable of analyzing the penetration of the weld, the weld seam impression, and the condition of one or more welding electrodes.

### SUMMARY OF THE INVENTION

In accordance with one aspect of the invention, a welding system having a welder with an electrode is disclosed. The welding system may include a thermal sensor for monitoring a first and second portion of the weld. The system may also include a processor for receiving data from the thermal sensor and generating an output relating to penetration of the weld, dimensions of the weld, or electrode wear. In one embodiment, the sensor may include an infrared camera. Also, the sensor may include a first and second thermal sensor, whereby the first thermal sensor monitors a top portion of the weld and the second thermal sensor monitors a bottom portion of the weld.

In one embodiment, the processor is configured for comparing the data from the thermal sensor to a preset temperature value or a range of temperature values. The processor may also be configured for comparing the data from the thermal sensor to a spatial arrangement of pixels. The output may include an alarm or a visual representation of the weld. The output may also indicate a physical location on the weld where a defect in the weld exists.

In accordance with another aspect of the invention, a welding system having a welder with at least one electrode for creating a weld is disclosed. The welding system may include a heat-reflector for reflecting a thermal profile of a first portion of the weld to a surface. It may also include a thermal sensor for receiving thermal data from the surface and thermal data directly from a second portion of the weld. The welding system may also include a processor for receiving data from the thermal sensor, and generating an output relating to penetration of the weld, dimensions of the weld, or electrode wear. In one embodiment, the surface is a blackbody. Also, the first portion of the weld may include the bottom of the weld and the second portion of the weld may include the top of the weld. The processor may be configured for comparing the data from the thermal sensor to a preset temperature value or a range of temperature values. In one embodiment, the processor is configured for comparing the data from the thermal sensor to a spatial arrangement of pixels.

In accordance with another aspect of the invention a method for monitoring a weld is disclosed. The method may include acquiring thermal data relating to a first portion of the weld, acquiring thermal data relating to a second portion of the weld, comparing the thermal data for the first and second portions, and generating an output based on the comparing. The output may relate to penetration of the weld, dimensions of the weld, or electrode wear. In one embodiment, the generating an output comprises activating an alarm or creating a visual representation of the weld. The comparing may include comparing the thermal data to a preset initial condition. The comparing may also include comparing the thermal data to a single temperature value or a range of temperature values. Also, the comparing may comprise comparing a spatial arrangement of pixels in a thermal image. The comparing may include comparing a dimensional measurement of the weld with a known measurement of an acceptable weld. The comparing may also include comparing a pattern of an impression of the weld with a known pattern of an acceptable weld.

In accordance with another aspect of the invention, a method for monitoring a seam weld is disclosed. The method may include acquiring thermal data from a first infrared camera relating to a top portion of the seam weld, acquiring thermal data from a second infrared camera relating to a bottom portion of the seam weld, setting an initial condition relating to one of a temperature, a range of temperatures, and a spatial arrangement of pixels in a thermal image, comparing the thermal data from the first and second infrared cameras with the initial condition, and generating an output based on the comparing. In one embodiment, the comparing includes comparing a dimensional measurement of the weld with a known measurement of an acceptable weld. The comparing may also include comparing a pattern of an impression of the weld with a known pattern of an acceptable weld.

### BRIEF DESCRIPTION OF THE DRAWINGS

FIG. 1 is a perspective view of a representative pair of parts to be welded;

FIG. 2 is a schematic representation of one embodiment of a welding system of the present invention;

FIG. 3 is a flow diagram illustrating one embodiment of the processor of the present invention;

FIG. 4a is a photograph of a thermal image;

FIGS. 4b-4e are representative thermal images of various weld impressions;

FIG. 5a is a front view of one embodiment of a rotating welding electrode;

FIG. 5b is a side view of the rotating welding electrode of FIG. 5a; and

FIG. 6 is a schematic representation of one embodiment of a welding system of the present invention.

### DETAILED DESCRIPTION OF THE INVENTION

In the following detailed description of the preferred embodiments, reference is made to the accompanying drawings that form a part hereof, and in which is shown by way of illustrations, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical and/or other changes may be made without departing from the scope of the present invention. In accordance with the present invention, a system and method for welding and real time monitoring of welded parts are hereafter described.

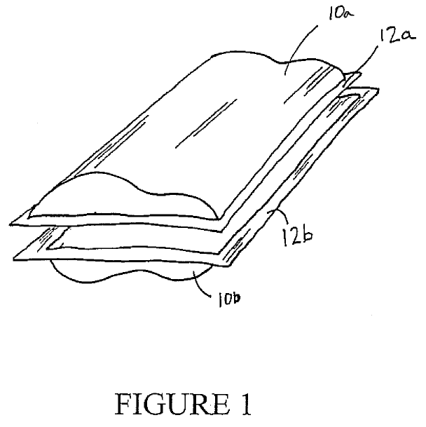

FIG. 1 illustrates a representative pair of parts 10a, 10b to be joined by seam welding. In particular, the parts 10a, 10b have been stamped from sheet material, as is well known in the art. The parts 10a, 10b include portions 12a, 12b that contact one another and create the area to be welded. Although a skilled artisan will appreciate that the parts 10a, 10b may form any desired structure, in the embodiment shown, the parts 10a, 10b when welded together form a vessel, such as a fuel tank for an automobile.

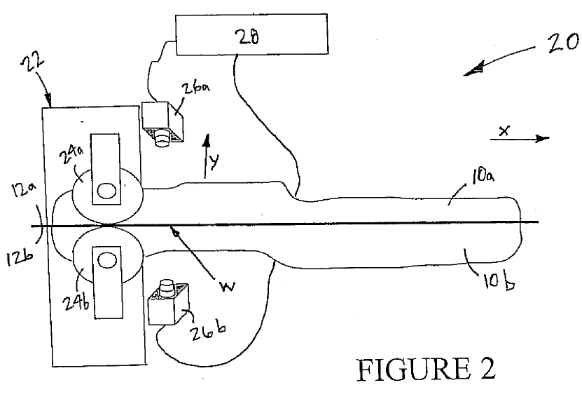

FIG. 2 illustrates one embodiment of a welding system 20 that may be used for welding the portions 12a, 12b of the parts 10a, 10b. As shown, the system 20 includes a welder, such as a seam welder 22 with two electrodes 24a, 24b. In one embodiment, the electrodes 24a, 24b comprise opposed rotating electrodes formed from copper or a copper alloy. As is characteristic with this configuration of welder, one of the electrodes 24a, 24b is provided with a positive voltage, while the other with a negative voltage. Depending on the configuration of the welder and the material being welded, the electrodes 24a, 24b may be provided with a voltage between 2 V and 12 V. When using copper electrodes 24a, 24b and welding two steel materials, the electrodes will be provided with a current of approximately 12 KAs to 22 KAs depending on the steel material type, material thickness, and welding schedules. The portions 12a, 12b fed through the electrodes 24a, 24b serve as a ground in the welding circuit. Accordingly, the pressure applied by the electrodes 24a, 24b and the current flowing through them results in a continuous weld W being formed along the portions 12a, 12b.

Adjacent to the welder 22, the system 20 includes a first and second sensor 26a, 26b for monitoring or analyzing the weld W or data relating to the weld W. Although the sensors 26a, 26b may comprise any form of sensors, in one embodiment, they comprise infrared cameras, such as FLIR SYSTEMS THERMOVISION® A20M infrared cameras. As discussed below, the thermal data captured by the sensors can be used to detect abnormalities or defects in the weld W and/or the electrodes 24a, 24b.

While the sensors 26a, 26b may be positioned anywhere, each sensor 26a, 26b preferably monitors different portions of the weld W. In the configuration shown in FIG. 2, the sensor 26a is positioned above the weld W to monitor a top portion of the weld W, while the sensor 26b is positioned below the weld W to monitor a bottom portion of the weld W. In other words, the sensor 26a monitors the portion 12a, while the sensor 26b monitors the portion 12b. However, a skilled artisan will appreciate that both sensors 26a, 26b could monitor the same portion 12a or 12b.

Although the sensors 26a, 26b may be fixed at any given location, they may also be configured for movement towards or away from the electrodes 24a, 24b and/or towards or away from the parts 10a, 10b. This allows for either movement of the parts 10a, 10b in relation to the sensors 26a, 26b being fixed at a certain position, or movement of the sensors in relation to fixed parts 10a, 10b.

Preferably, the sensors 26a, 26b are located a distance between 90 mm and 900 mm (depend on the geometry and size of the welded object) in the direction Y away from the weld W, while located a distance between 200 mm and 1600 mm (depend on the geometry and size of the welded object) in the direction X away from the electrodes 24a, 24b when acquiring data from the parts 10a, 10b. One will appreciate that this positioning enables the sensors 26a, 26b to capture real time thermal data of different portions of the weld W. Specifically, the proximity of the sensors 26a, 26b to the welder 22 enables the weld W to be monitored immediately or soon after it is formed. Unlike prior weld inspection methods, there is no need to remove the part from the welding system 20 or welder 22 to inspect the weld W. Rather, the weld W may be analyzed in real time as it exits the electrodes 24a, 24b. This allows for substantially simultaneous welding and analysis of the subsequent weld.

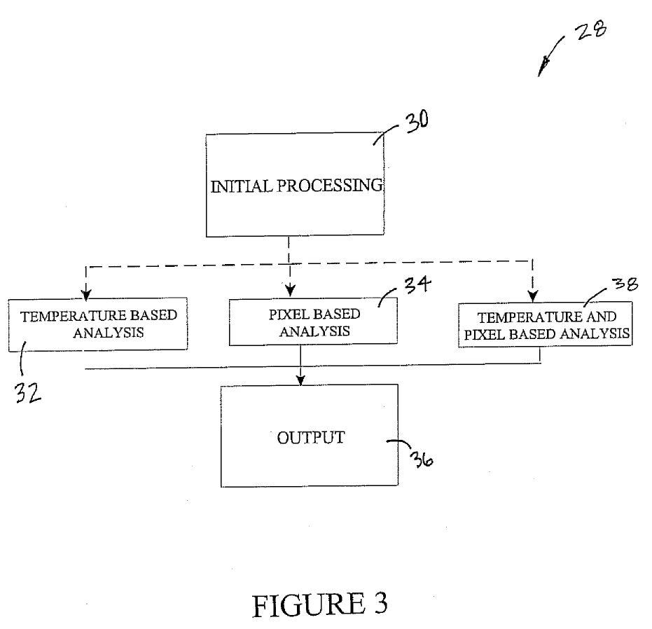

After capturing the thermal data, each of the sensors 26a, 26b communicate this information to a processor 28 via a wired, wireless, or other connection. FIG. 3 shows a flow diagram illustrating one embodiment of the processor 28 of the present invention. The processor 28 may comprise a computer configured to log data and perform comparison and analysis of data recorded. In one embodiment, the computer utilizes a thermal imaging software package specifically adapted for use with the sensors 26a, 26b. When using FLIR SYSTEMS THERMOVISION® A20M infrared cameras, an appropriate software package may include the FLIR SYSTEMS THERMACAM RESEARCHER software.

At step 30, the thermal data is initially processed. This may result in the processor 28 comparing the data to initial conditions or values set by a user, stored in the processor 28, or otherwise accessible by the processor 28. Some of these initial conditions or values may include values relating to the type of material being welded, specifications relating to the welder (e.g., electrodes, voltages, etc.) or data relating to the system. In one embodiment, the initial conditions relate to a minimum temperature value or range of temperature values that are acceptable for the present welding process. In other words, this may be a value or range of values that are known to create an acceptable weld.

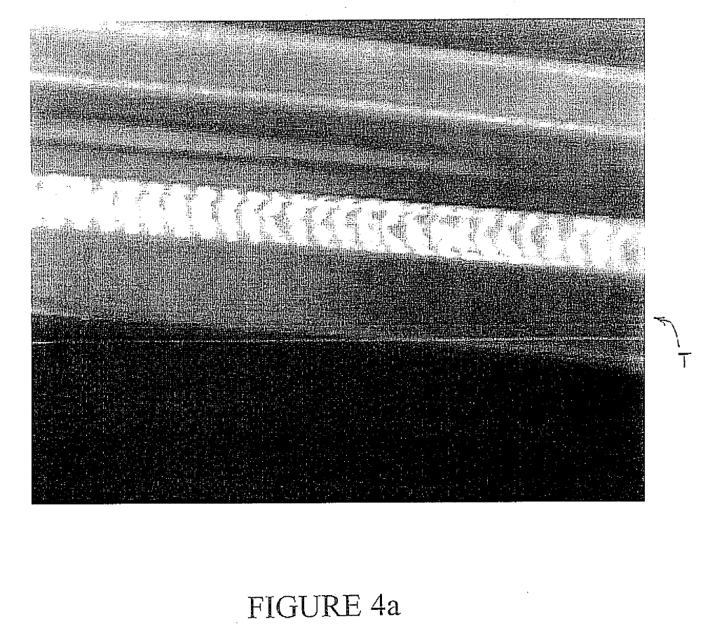

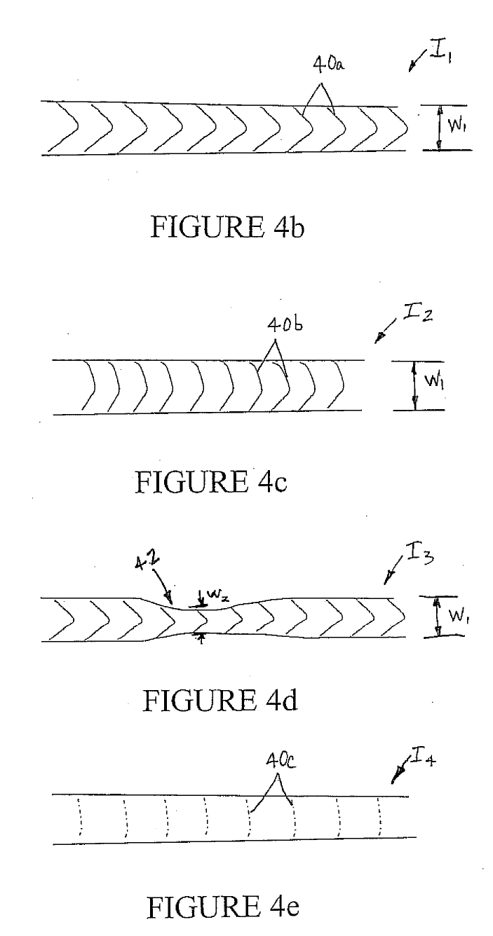

Also, the thermal data may be converted into a user-viewable thermal image T (FIG. 4a) that may be displayed or otherwise used by the processor 28. In creating the thermal images, some or all of the thermal data may be compared to one or more of the aforementioned initial conditions. A skilled artisan will appreciate that this thermal image T may be created by the sensors 26a, 26b, the processor, or otherwise. After the initial processing and creation of the thermal images, the data and/or images may be further manipulated to remove non-value added data. With regard to the thermal images, this may result in removal of excess portions of the image background that will not be used in subsequent analysis. For instance, if certain portions of the thermal image relate to temperatures or other data that is located in areas outside of the weld area or otherwise not needed during the analysis discussed below, this data may be removed from the image. This may also result in manipulation of the thermal image based upon the preset minimum temperature or temperature range relating to the welding process or other preset values. Other preprocessing might include computing the background pixels and then subtracting such pixels from the acquired images. This will optimize the identification of the target image, and also reduce the data size and improve the processing speed.

After initial processing, at steps 32 and 34 a temperature and/or pixel based analysis is performed on the thermal data and/or thermal images. With regard to the temperature based analysis (step 32), the processor compares the thermal data of the first part 10a with a preset temperature value. As discussed above, the preset temperature value may be provided by a user at step 30, stored in the processor 28, and/or otherwise accessible by the processor 28. Since two sensors 26a, 26b are used, the thermal data of the second part 10b is also compared with the preset temperature value. A skilled artisan will appreciate that use of two sensors 26a, 26b enables the temperature based analysis to result in a penetration check of the weld. Specifically, when the sensors 26a, 26b are positioned on opposite sides of the weld W (such as the symmetrical arrangement shown in FIG. 2), they are able to provide independent thermal data from each side of the weld W. If the temperatures obtained by either of the sensors 26a, 26b are outside of the preset value, this is an indication that there may be insufficient weld penetration. In other words, this indicates that the portions 12a, 12b were not exposed to a sufficient temperature during welding to result in adequate fusion of the portions 12a, 12b. If this occurs, the processor may provide an appropriate output (step 36), as discussed below. Furthermore, the top and bottom pixels may be “normalized” (i.e. top seam temperature is divided by bottom seam temperature to produce a ratio) this ratio will be compared to a “known” ratio that indicates good penetration of the seam.

In addition to or in lieu of the temperature based analysis, the processor 28 may also perform a pixel based analysis (step 34), such as a pixel count analysis, of thermal images to determine if the weld W is within an acceptable spatial configuration range. Preferably, the pixel-count based analysis would be performed on a thermal image created from the thermal data, as discussed above. In particular, this analysis uses an algorithm stored or otherwise accessible by the processor 28 to compare the number and configuration of pixels in a portion of a thermal image with a known preset range or configuration of pixels. In one embodiment, the pixel count will be correlated with an instantaneous field of view IFOV of the camera and optics combination to produce the seam dimensions in unit lengths e.g. mm or inches. The correlation is simply done by multiplying the number of pixels in each direction by the IFOV. However, the seam orientation should be checked to confirm that the camera is substantially perpendicular to the seam plane. If the orientation is not accurate, then a projection correction factor should be added to correct for a view factor between the camera optics and the seam.

In another embodiment, this may result in a user inputting or otherwise setting a known spatial configuration of pixels of an acceptable weld impression. Once this is set, the processor 28 may compare this acceptable configuration of pixels to those of another thermal image, such as a current part being welded.

FIG. 4b shows a representative thermal image of an acceptable weld impression I₁ for the first sensor 26a, while FIG. 4c shows a representative thermal image of an acceptable weld impression I₂ for the second sensor 26b. As shown, the impressions I₁ and I₂ have a substantially constant width W₁ and reoccurring patterns 40a, 40b extending across the width W₁. The width W₁ and patterns 40a, 40b are created by the electrodes 24a, 24b of the welder 22. This substantially constant width W₁ and reoccurring patterns 40a, 40b create a specific spatial arrangement of pixels in the thermal image. This spatial arrangement of pixels for an acceptable weld can be used to set a “baseline” for analyzing subsequent thermal images of the welds W, as well as the condition of the electrodes 24a, 24b.

If the impression of the weld W deviates from the baseline impression, this indicates that the weld W may be insufficient and/or that the condition of the electrodes has deteriorated. For example, FIG. 4d shows a weld impression I₃ without a substantially continuous width W₁. Instead, this impression includes a region 42 (FIG. 4d) having a width W₂, which is less than W₁. This difference in widths creates a spatial configuration of pixels unique from the acceptable weld impressions I₁, I₂ shown in FIGS. 4b and 4c.

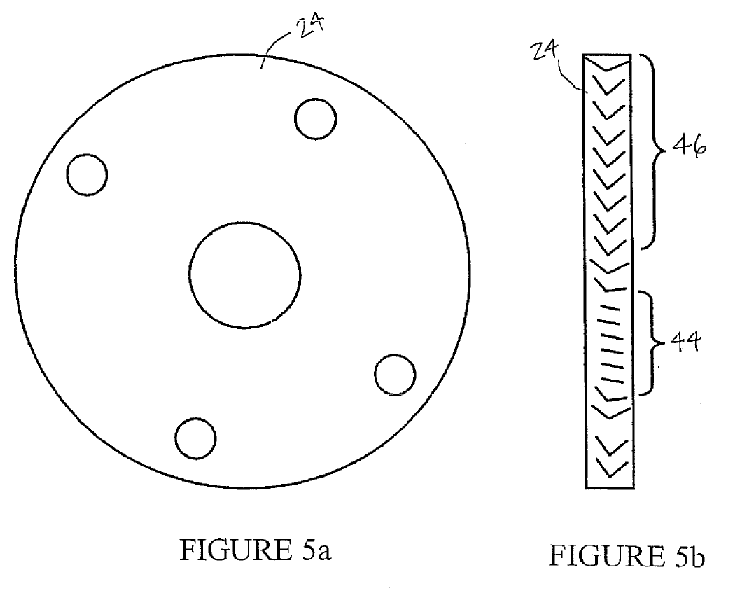

Besides detecting a change in the width the impression, the pixel based analysis may also detect a change in the impression patterns 40a, 40b. FIG. 4e shows a thermal image of a weld impression I₄ with an anomalous pattern 40c. This pattern 40c has been created by an electrode 24 (FIG. 5a) that has become worn from use or otherwise has deteriorated.

As shown in FIG. 5b, the electrode 24 includes a portion having a worn profile 44 and a portion having a good or acceptable profile 46. The worn profile 44 creates the anomalous pattern, such as the pattern 40c shown in FIG. 4e. When comparing the pixel configuration of the impression in FIG. 4e with those in FIGS. 4b and 4c, the processor can detect the differences between them and produce an appropriate output, as discussed below. Again, as previously mentioned, the pixel based analysis and the temperature based analysis may occur independent of one another (steps 32 and 34). Alternatively, both of these analyses may be performed together (step 38).

Next, step 36 provides an output based one or both of the temperature or pixel based analyses. This output may take the form of a visual or audible alarm and/or a visual representation of the weld that may be displayed on a monitor. For instance, if the temperature or pixel based analysis indicates that one or both of the portions 12a, 12b are below the preset minimum or otherwise outside the preset designated range of values, a visual or audible alarm may activate to warn the user that the weld is inadequate and/or the electrode is abnormal. Other visual or audible alarms may also be activated if an entire part 10a, 10b is welded without any defect found in the weld W or electrodes 24a, 24b.

Besides activating an alarm and/or displaying a visual representation of the weld, the output may also be linked to the welder 22. In particular, if the output of one or both of the temperature or pixel based analyses is outside of the preset values, then the processor 28 may direct the welder 22 to cease welding. Alternatively, the processor 28 could be configured to change one or more of the welding parameters, such as the voltages of the electrodes 24a, 24b while the welder continues to weld.

The output (step 36) may also be synchronized to indicate the physical location on the weld where the sensors 26a, 26b provided data to the processor 28 indicating an abnormality in the weld W. Specifically, by knowing the distance of the sensors 26a, 26b from the electrodes 24a, 24b, the processor 28 is able to calculate the location on the weld W where the abnormality was discovered. This location could be provided to the user in a visual format, such as a graphical representation of the part on a display. Providing the location of the potential weld defect enables a user to quickly further inspect that specific location of the part to determine if the part is acceptable, needs to be welded again, or scrapped.

In summary, the present invention presents a system and method for welding and nondestructive, real time inspection and monitoring of welded parts. The system and method are capable of analyzing the penetration of the weld, the weld seam impression, and the condition of one or more welding electrodes.

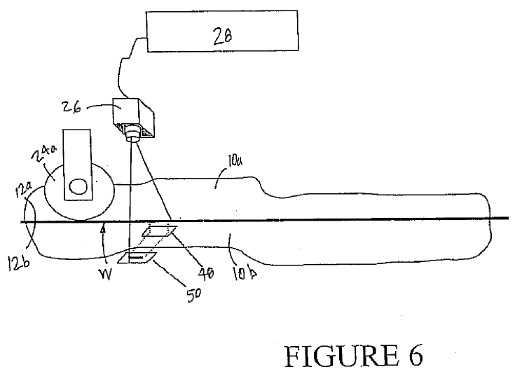

The foregoing discussion was chosen to provide the best illustration of the principles of the invention and its practical application to thereby enable one of ordinary skill in the art to utilize the invention in various embodiments and with various modifications suited to the particular use contemplated. Besides the two sensors 26a, 26b discussed herein, a skilled artisan will appreciate that a single sensor 26 may be used to obtain data from two or more locations on one or more parts 10a, 10b. Also, a single electrode 24 may be used if desired. For instance, as shown in FIG. 6, a single sensor 26 may receive thermal data from multiple locations. As shown, the sensor 26 acquires thermal data from a first portion of the part 10a or 10b, while a heat-reflector, such as a mirror or 48, reflects thermal data or a thermal profile from a second portion of one of the parts 10a, 10b into a blackbody 50, such as a surface treated with a specialized coating. The sensor is configured to receive thermal data directly from one of the parts 10a, 10b, while also receiving thermal data from the blackbody 50. All modifications and variations are within the scope of the invention as determined by the appended claims when interpreted in accordance with the breadth to which they are fairly, legally and equitably entitled.

What is claimed:

1. A welding system having welder with an electrode for creating a weld, comprising:
a thermal sensor for monitoring a first and second portion of the weld;
a processor for receiving data from the thermal sensor and generating an output relating to penetration of the weld, dimensions of the weld, or electrode wear.

2. The welding system of claim 1, wherein the sensor comprises an infrared camera.

3. The welding system of claim 1, wherein the thermal sensor comprises a first and second thermal sensor, whereby the first thermal sensor monitors a top portion of the weld and the second thermal sensor monitors a bottom portion of the weld.

4. The welding system of claim 3, wherein the first and second thermal sensors are positioned on opposite sides of the weld.

5. The welding system of claim 1, wherein the processor is configured for comparing the data from the thermal sensor to a preset temperature value or a range of temperature values.

6. The welding system of claim 1, wherein the processor is configured for comparing the data from the thermal sensor to a spatial arrangement of pixels.

7. The welding system of claim 1, wherein the output is an alarm or a visual representation of the weld.

8. The welding system of claim 1, wherein the output indicates a physical location on the weld where a defect in the weld exists.

9. A welding system having a welder with at least one electrode for creating a weld, comprising:
a heat-reflector for reflecting a thermal profile of a first portion of the weld to a surface;
a thermal sensor for receiving thermal data from the surface and thermal data directly from a second portion of the weld; and
a processor for receiving data from the thermal sensor, and generating an output relating to penetration of the weld, dimensions of the weld, or electrode wear.

10. The welding system of claim 9, wherein the surface is a blackbody.

11. The welding system of claim 9, wherein the thermal sensor is an infrared camera.

12. The welding system of claim 9, wherein the first portion of the weld is the bottom of the weld and the second portion of the weld is the top of the weld.

13. The system of claim 9, wherein the processor is configured for comparing the data from the thermal sensor to a preset temperature value or a range of temperature values.

14. The system of claim 9, wherein the processor is configured for comparing the data from the thermal sensor to a spatial arrangement of pixels.

15. The system of claim 9, wherein the output is an alarm or a visual representation of the weld.

16. A method for monitoring a weld, comprising:
acquiring thermal data relating to a first portion of the weld;
acquiring thermal data relating to a second portion of the weld;
comparing the thermal data for the first and second portions; and
generating an output based on the comparing, said output relating to penetration of the weld, dimensions of the weld, or electrode wear.

17. The method of claim 16, wherein the generating an output comprises activating an alarm or creating a visual representation of the weld.

18. The method of claim 16, wherein the comparing comprises comparing the thermal data to a preset initial condition.

19. The method of claim 16, wherein the comparing comprises comparing the thermal data to a single temperature value or a range of temperature values.

20. The method of claim 18, wherein the comparing comprises comparing a spatial arrangement of pixels in a thermal image.

21. The method of claim 20, wherein the comparing includes comparing a dimensional measurement of the weld with a known measurement of an acceptable weld.

22. The method of claim 20, wherein the comparing includes comparing a pattern of an impression of the weld with a known pattern of an acceptable weld.

23. The method of claim 16, wherein the acquiring thermal data relating to the first and second portions of the weld occurs simultaneously.

24. A method for monitoring a seam weld, comprising:
acquiring thermal data from a first infrared camera relating to a top portion of the seam weld;
acquiring thermal data from a second infrared camera relating to a bottom portion of the seam weld;
setting an initial condition relating to one of a temperature, a range of temperatures, and a spatial arrangement of pixels in a thermal image;
comparing the thermal data from the first and second infrared cameras with the initial condition; and
generating an output based on the comparing.

25. The method of claim 24, wherein the comparing includes comparing a dimensional measurement of the weld with a known measurement of an acceptable weld.

26. The method of claim 24, wherein the comparing includes comparing a pattern of an impression of the weld with a known pattern of an acceptable weld.

27. The method of claim 24, wherein the acquiring thermal data relating to the first and second portions of the weld occurs simultaneously.
